(19) United States
(12) Patent Application Publication
(10) Pub. No.: US 2015/0032529 A1
(43) Pub. Date: Jan. 29, 2015

(54) SYSTEM AND METHOD FOR ENHANCING CUSTOMER LOYALTY

(71) Applicant: Vasilii Vladimirovich DIACHENKO, Saint Petersburg (RU)

(72) Inventor: Vasilii Vladimirovich DIACHENKO, Saint Petersburg (RU)

(21) Appl. No.: 14/471,468

(22) Filed: Aug. 28, 2014

Related U.S. Application Data
(63) Continuation-in-part of application No. PCT/RU2012/000887, filed on Oct. 30, 2012.

(30) Foreign Application Priority Data
Feb. 28, 2012 (RU) PCT/RU2012/000139

(51) Int. Cl. G06Q 30/02

(52) U.S. Cl. CPC G06Q 30/0226
USPC 705/14.27

(57) ABSTRACT

The present invention relates to a system and a method for enhancing consumer loyalty with a mobile device. The system comprises at least one processing center comprising a processing means for generating at least first and second data, the first data corresponding to a first seller registered in the at least one processing center and second data corresponding to a second seller registered in the at least one processing center. The processing center is capable to communicate the generated first and second data and capable to receive and update data, and comprises a data storage for storing at least the generated first and second data. The system also comprises mobile device registered in the at least one processing center, wherein each mobile device of the at least one mobile device receives at least one of the communicated first data and second data and further generates mobile device data corresponding to at least one of the received data. The system further comprises at least one validator registered in the at least one processing center and comprising a validator reader for reading the generated mobile device data from the at least one mobile device, wherein each validator of the at least one validator generates validator data corresponding to the read mobile device data and communicates the generated validator data to the at least one processing center; wherein each processing center of the at least one processing center receives the communicated validator data to store in the corresponding data storage and further updates at least one of the first data and second data on the basis of the validator data.

### CROSS-REFERENCE TO RELATED APPLICATIONS

This application is a continuation-in-part of International Application PCT/RU2012/000887 filed on Oct. 30, 2012, which claims priority benefits to International Application PCT/RU2012/000139 filed on Feb. 2, 2012, the entire disclosures of which are incorporated herein by reference.

### BACKGROUND OF INVENTION

1. Field of Invention

The present invention generally relates to systems and methods for enhancing customer loyalty with a mobile device.

2. Description of Related Art

Many efforts have been made to improve customer loyalty systems as evidenced by representative prior art described below.

In particular, in RU 2343542 or corresponding RU 2006110237 disclosed is a system for improving customer loyalty, the system comprising processing center, at least one mobile device each having a unique mobile device identifier (mobile device ID), the unique mobile device ID being assigned upon registration in the processing center and a point-of-sale terminal, wherein every mobile device of the at least mobile device comprises mobile device communicating means for communicating with the processing center and point-of-sale terminal and receives from the processing center data on promotion programs of every seller registered in the processing center, and wherein the point-of-sale terminal comprises terminal input means for entering data corresponding to certain mobile device ID, terminal reading means for reading mobile device data corresponding to the mobile device ID from certain mobile device of the at least one mobile device, and terminal communicating means for communicating terminal data to the processing center, the terminal data comprising read mobile device data and/or entered data and corresponding to mobile device ID, and wherein the processing center processes the received validator data and communicates the processed validator data to the same mobile device of the at least one mobile device.

The system used in RU 2343542 or corresponding RU 2006110237 for improving customer loyalty has a significant disadvantage, specifically significant volume of excessive data communicated from the processing center to certain mobile device of the at least one mobile device.

### SUMMARY OF INVENTION

An object of the present invention is to provide an improved method for enhancing customer loyalty and an improved system based on the improved method, the method and device allowing improved filtering of data flow communicated from processing center to mobile devices connected therewith.

To archive the object of the invention, as embodied and broadly described herein, in one aspect of the invention there is provided a system for enhancing customer loyalty with a mobile device, the system comprising: at least one processing center comprising a processing means for generating at least first data and second data, the first data corresponding to a first seller registered in the at least one processing center and second data corresponding to a second seller registered in the at least one processing center, wherein the at least one processing center is capable to communicate the generated first data and second data and capable to receive and update data, and further comprises a data storage for storing at least the generated first data and second data; at least one mobile device registered in the at least one processing center, wherein each mobile device of the at least one mobile device receives at least one of the communicated first data and second data and further generates mobile device data corresponding to at least one of the received data; the system further comprising at least one validator registered in the at least one processing center and comprising a validator reader for reading the generated mobile device data from the at least one mobile device, wherein each validator of the at least one validator generates validator data corresponding to the read mobile device data and communicates the generated validator data to the at least one processing center; wherein each processing center of the at least one processing center receives the communicated validator data to store in the corresponding data storage and further updates at least one of the first data and second data on the basis of the validator data.

In another aspect of the invention there is provided a method for enhancing consumer loyalty with a mobile device, the method including the steps of generating at least first data and second data by at least one processing center, the first data corresponding to a first seller registered in the at least one processing center and second data corresponding to a second seller registered in the at least one processing center, and further storing the generated first data and second data in a data storage of the corresponding processing center; receiving at least one of the generated first data and second data by the at least one mobile device registered in the at least one processing center, the received data being communicated from the at least one processing center; generating mobile device data by at least one registered mobile device, the generated mobile device data corresponding to at least one of the received data; reading the generated mobile device data by at least one validator; generating validator data by the at least one validator, the validator data corresponding to the read mobile data and communicating the generated validator data to the at least one processing center; receiving the communicated validator data by at least one processing center and storing the received validator data in the data storage of the corresponding processing center; updating at least one of the first data and second data stored in the corresponding data storage of the at least one processing center on the basis of the received validator data.

The above mentioned system or method allows filtering the unique data which a certain mobile device of the at least one mobile device receives from the at least one processing center. In addition, the system or method allows reducing the usage of mobile device resources, such as mobile device processor or microcontroller resources, RAM and ROM resources and other mobile device resources, because the mobile device receives the filtered unique data to be further recorded into the mobile device data storage of the mobile device. Thus, the above achieved technical effect provides enhanced loyalty to a certain seller participating in the loyalty program but not to all participating sellers and/or another seller participating in the loyalty program (for example when a user buys some products/services in a sales outlet of one seller and further obtain reward points additionally credited for the bought products/services, but spends the credited reward points in a sales outlet of another seller also participating in the loyalty program). Moreover, the system or method for enhancing customer loyalty allows the extending life cycle of the ROM storing the unique data received by the mobile device.

In one embodiment of the present invention, each mobile device of the at least one mobile device may be a mobile phone.

In another embodiment of the present invention, each validator of the at least one validator may be a mobile phone, communicator or tablet PC.

In one embodiment of the present invention, each validator of the at least one validator may further comprise input means for entering data, and the generated validator data correspond to the read mobile device data and/or the entered data.

In another embodiment of the present invention, the input means of the at least one validator may be a keyboard and/or at least one button.

According to still another embodiment of the present invention, each mobile device of the at least one mobile device may further comprise input means for entering data and capable to communicate the entered data to the at least one processing center to update at least one of the first data and second data on the basis of the communicated data.

According to yet another embodiment of the present invention, the input means of the at least one mobile device may be a keyboard and/or at least one button.

According to yet another embodiment of the present invention, each validator of the at least one validator may further comprise a validator display for displaying the mobile device data read by corresponding validator reader. The validator display allows a user of the validator to visually control correctness of reading the mobile device data and/or entering the data with the input means of the validator.

According to one embodiment of the present invention, the validator display may by a touch screen display or a touch screen display and at least one button.

According to another embodiment of the present invention, each mobile device of the at least one mobile device may further comprise a mobile device display for displaying the generated mobile device data.

According to some embodiments of the present invention, the mobile device display may be a touch screen display or a touch screen display and at least one button. Such configuration of the mobile device display and mobile device input means facilitates control of operations corresponding to the unique data by a user of the mobile device.

According to still another embodiment of the present invention, the validator reader of each validator of the at least one validator may be a camera for capturing the mobile device data displayed by the mobile device display.

According to yet another embodiment of the present invention, each validator of the at least one validator may further comprise a recognizer for recognizing the mobile device data captured by the camera.

In one embodiment of the present invention, the validator reader of each validator of the at least one validator may be a scanner for scanning the mobile device data displayed by the mobile device display.

In another embodiment of the present invention, the generated mobile device data may be a code, the code being displayed by the corresponding mobile device display.

In still another embodiment of the present invention, the code may be a QR code or NFC code.

In yet another embodiment of the present invention, the generated mobile device data may be a QR code or NFC code.

In some embodiments of the present invention, each validator of the at least one validator may collect the read mobile device data when said each validator is not connected with the at least one processing center. Such option of the validator allows faultless operation of the system when the connection between the validator and processing center is not established.

According to one embodiment of the present invention, each validator of the at least one validator may send a request to the at least one processing center for comparing certain read mobile device data with at least one of the first data and second data stored in the corresponding data storage and receiving a center response from the corresponding processing center, the response corresponding to the sent request. Such option of the validator allows a user of the system to prevent possible failures in the system by preliminary testing the content of validator data to be communicated to the processing center for further processing.

According to yet another embodiment of the present invention, wherein each processing center of the at least one processing center may be a server, website or satellite.

Additional features and advantages of the invention will be set forth in part in the description which follows and in part will be obvious from the description, or may be learned by practice of the invention. The above objective and other advantages of the invention are realized and attained by the above system and method particularly pointed out in the description and claims hereof as well as the appended drawing.

Moreover, it is to be understood that both the foregoing general description and the following detailed description are exemplary and explanatory only and are not restrictive of the invention, as described. The invention is defined by the attached set of claims. Further features and/or variations may be provided in addition to those set forth herein. For example, the present invention may be directed to various combinations and subcombinations of the disclosed features and/or combinations and subcombinations of several further features disclosed below in the detailed description.

### BRIEF DESCRIPTION OF THE DRAWINGS

The accompanying drawings, which are incorporated in and constitute a part of the description, illustrate various embodiments and aspects of the present invention and, together with the description, explain the principles of the invention. In the drawings:

FIG. 1 is a system for enhancing customer loyalty.

### DESCRIPTION OF THE PREFERRED EMBODIMENTS

Reference will now be made in detail to the invention, examples of which are illustrated in the accompanying drawings. Wherever possible, the same reference numbers will be used throughout the description to refer to the same or like parts.

According to the present invention, a system 0 represents a loyalty program intended to increase loyalty of customers having a mobile device to a certain seller participating in the loyalty program, the seller offering differing services and/or products having at least one sales outlet.

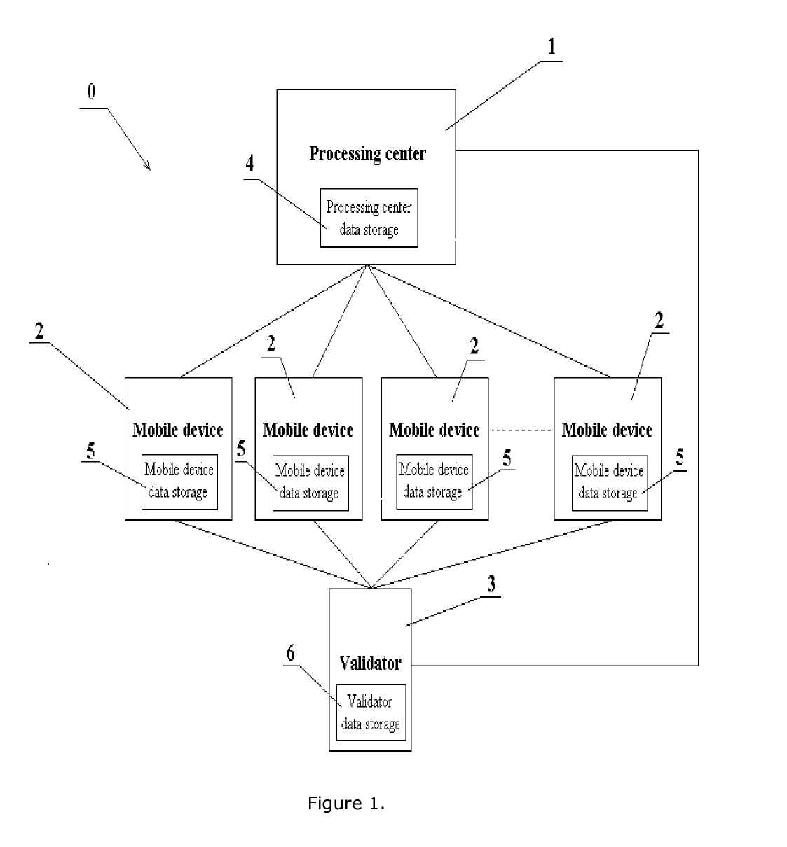

FIG. 1 shows a system 0 for enhancing consumer loyalty comprises a processing center 1 comprising a processing center data storage 4, at least one mobile device 2 each comprising a mobile device data storage 5 and at least one validator 3 each comprising a validator data storage 6. In one embodiment of the present invention system 0 for enhancing customer loyalty may comprise at least two processing centers 1 each having at least one data storage 4.

A new seller becomes a participant of the loyalty program upon registration in the processing center 1 by means of a website of the loyalty program, the website having an unique URL address and being comprised of a group of connected website pages on the World Wide Web. The pages contain data on the loyalty program and virtually representing website data of the loyalty program website, the website data being stored in the processing center data storage 4 of the processing center 1.

The processing center 1 further comprises processing means for processing data stored in the processing center data storage 4, and the processing center data storage 4 further stores a processing center seller database, the processing center seller database comprising processing center seller database elements each corresponding to a certain seller and being filled at least by seller data of the certain seller. The processing center seller database stored in the processing center data storage 4 is controlled by the processing center processing means of the processing center 1.

A new seller visits the website using its URL address and completes a new seller registration process such that to register in the processing center 1. The new seller registration process includes entering personal data of the new seller, selecting certain elements among graphic elements, letter elements and/or numerical elements available at the website and/or designing such elements at the website by means of specific website tools to form a unique logotype identifying the new seller among other sellers, for instance graphically, wherein the graphic elements, letter elements and/or numerical elements available at the loyalty program website are initially stored in the processing center data storage 4, and data on the selected and/or designed elements and entered personal data are recorded into a certain processing center seller database element, the certain processing center seller database element corresponding to the new seller and being stored in the processing center data storage 4 of the processing center 1. The unique logotype of the new seller is generated by the processing means of the processing center 1 on the basis of the data on selected and/or designed elements, the data recorded into an element of processing center seller database, the element being stored in the processing center data storage 4 as a part of the processing center seller database, wherein data on the generated unique logotype are also recorded into said element of the processing center seller database. When the new seller registration process is completed, a personal account is created at the loyalty program website by the processing means of the processing center 1 for the registered new seller on the basis of entered seller data of the certain seller and website data of the loyalty program website. A login and password is assigned to the registered new seller to access to the personal account. In particular, as described above, at least a first seller and a second seller may be registered in the processing center 1, wherein the first account is created at the loyalty program website for the registered first seller on the basis of entered seller data of the first seller and website data of the loyalty program website, and the second account is created at the loyalty program website for the second seller on the basis of entered seller data of the second seller and website data of the loyalty program website.

The personal account corresponds to a certain element of the processing center seller database stored in the processing center data storage 4 and allows the registered new seller to record desired seller data into the certain element of the processing center seller database via the loyalty program website and/or update some seller data recorded thereinto before the updating, wherein the recorded seller data are news data, advertisement data, data on seller special offers, data on events organized by the seller and/or etc.

Furthermore, a seller identifier (hereinafter seller ID) identifying a seller is assigned to the seller upon registration of the seller in the processing center 1. The processing center data storage 4 stores a program code of a basic program application capable to be customized for each registered seller on the basis of data corresponding to said each registered seller. The processing means of the processing center 1 further generate a customized program application based on the basic program application and representing unique content for the registered seller, the unique content corresponding to the generated seller logotype and the assigned seller ID of the registered seller, wherein the generated customized program application is stored in the processing center data storage 4 of the processing center 1, and unique content data associated with the generated program application are stored in a certain element of the processing center seller database, the element corresponding to the certain registered seller. In the case when at least the first seller and the second seller are registered at the loyalty program website, the first registered seller has an assigned first seller ID and the second registered seller has a second seller ID. A first program application and second program application are generated for the first seller and second seller, respectively, the first application representing first unique content for the first seller and being stored in a first element of the processing center seller database and the second application representing second unique content for the second seller and being stored in a second element of the processing center seller database.

A unique program application URL address is associated with each of the generated program applications upon the generation for remotely downloading the program application.

According to the present invention, the processing center 1 of the system 0 is a remote computer, and the processing means of the processing center 1 are commercially available central processing unit (hereinafter CPU) of the remote computer, the CPU having at least one core and performing at least operations on generating a logotype for a new seller, creating a personal account for the new seller, generating a customized software application for the new seller, and controlling data stored in the computer data storage of the computer according to the instructions for the CPU. The processing data storage 4 of the processing center 1 is a commercially available data hard-drive disk (hereinafter HDD) of the remote computer.

According to other embodiments of the present invention, the processing center processing means of the processing center 1 may be in the form of CPU and/or at least one general purpose processor and/or at least one microcontroller provided with at least one programmer to upload control software comprising desired instructions for the microcontroller. In still another embodiment of the present invention, the processing center 1 may be in the form of server, website or satellite.

Furthermore, processing center data storage 4 of the processing center 1 may be in the form of commercially available data medium of any type. For example, in various embodiments the processing center data storage 4 may be in the form of at least two HDD, RAID drive, solid-state drive (SSD), magnetic disc, spinning drive or optical disc, or at least one memory card, such as SD card, MMC card, SmartMedia card, Memory stick, Compact Flash card, PC card of I, II and III types and CardBus type, Miniature card, xD Picture card, MirrorBit Flash card and other types of memory cards, or in the form of any combination thereof, or the processing center data storage 4 may be implemented by any memory technologies that may be known or developed in the prior art. Thus, in the various embodiments of the present invention the processing center 1 may comprise specific readers integrated into the processing center 1, the specific readers reading data recorded into one of the above mentioned data mediums and writing desired data thereinto as well, and/or at least one specific slot for receiving at least one of the above mentioned data mediums.

Furthermore, in some other embodiments of the invention, the processing center 1 may comprise a first processing center data storage for storing website data of the loyalty program website, a second processing center data storage for storing graphic elements, letter elements and/or numerical elements available at the loyalty program website, and a third processing center data storage for storing a processing center seller database comprising recorded seller data, data on the selected and/or designed elements, data on a generated unique logotype and personal seller data entered during registration at the loyalty program website. In addition, the above mentioned processing center data storages may be comprised in at least one of the above mentioned data mediums and integrated with each other in any combination.

According to one another embodiment of the invention, website data of the loyalty program website may be stored in a data storage of an additional remote server, the additional remote server having processing means for controlling the website data stored in the server data storage and being connected with the processing center 1 in a wire and/or wireless manner such that to communicate desired data to the processing center 1 from the additional remote server.

According to still another embodiment of the present invention, a customized software application generated by the processing means of the processing center 1 may be communicated from the processing center 1 to any other remote server to store the customized software application in a data storage of the remote server.

A user of a mobile device, such as mobile device 2 comprising mobile device data storage 5, becomes a participant of the loyalty program as a customer upon registration of the user mobile device 2 in the processing center 1 of the system 0. A new user downloads a desired program application customized to a desired seller from the processing center 1 using a mobile device 2 having a wire and/or wireless internet connection and mobile device input means for entering a unique program application URL address of the desired program application, and mobile device processing means to install it in the mobile device 2. Moreover, each of generated program applications comprises special instructions for mobile device processing means of the mobile devices such that to periodically request a connection between a mobile device comprising the installed program application and a processing center. Therefore, according to the present invention, upon installation of the desired program application in the mobile device 2, the installed program application requests a wire or wireless connection between the mobile device 2 and processing center 1 by communication of special instruction to the mobile device processing means of the mobile device 2, and the mobile device 2 communicates unique mobile device data by means of a mobile device transmitter integrated into the mobile device 2 to the processing center 1 such that to register therein, the unique mobile device data corresponding to a certain mobile device 2 and certain seller ID integrated into the installed program application when the connection between the processing center 1 and mobile device 2 is established. The installed program application is recorded into a certain element of the mobile device seller database stored in the mobile device data storage 5 of the mobile device 2.

Upon receiving the communicated unique mobile device data by a processing center receiver integrated into the processing center 1, the processing center 1 stores the unique mobile device data in a certain element of the processing center seller database stored in the processing center data storage 4 and assign a unique mobile device identifier (mobile device ID) to the mobile device 2 which unique mobile data are received, wherein the assigned mobile device ID is stored in the same element of the processing center database. The assigned mobile device ID is communicated by means of a processing center transmitter, the processing center transmitter being integrated into the processing center 1, from the processing center 1 to the mobile device 2 as a part of initial unique data of a certain seller within an initial processing center data flow, the initial unique data further comprising at least a seller ID of the certain seller and initial seller data entered by the certain seller during the registration in processing center 1 and recorded into a certain element of the processing center seller database stored in the processing center data storage 4, wherein the initial seller data correspond to the seller ID and the initial unique data may be updated by data which may be communicated to the processing center 1 from at least one device connected therewith in a wire and/or wireless manner. The mobile device 2 receives the initial unique data by a mobile device receiver integrated into the mobile device 2 and records the received initial unique data into the certain element of the mobile device seller database stored in the mobile device data storage 5 of the mobile device 2, the initial unique data being transmitted by the processing center transmitter of the processing center 1.

In particular, in the case when at least the first seller and the second seller are registered at the loyalty program website, a user of a mobile device may install in the mobile device at least one of the first and second program applications. If the user of the mobile device installs particularly the first program application, the mobile device communicates to the processing center first unique mobile device data corresponding exceptionally to said mobile device and to the first seller ID which is integrated into the installed first program application. The processing center 1 communicates first initial unique data corresponding to the first seller to the mobile device with corresponding mobile device ID. Besides the first program application, the user of the mobile device may install a second program application or both first and second program applications.

Furthermore, when the initial seller data are updated by the seller with new seller data entered from a personal account of the seller at the loyalty program website and/or the initial unique data are updated by data received from the at least one device connected with the processing center 1 in a wire and/or wireless manner and when a connection between the processing center 1 and mobile device 2 is established, the processing center 1 communicates updated unique data to a certain mobile device 2 within an updated processing center data flow, the updated unique data corresponding to a certain seller ID and certain mobile device ID. When the updated unique data are received by the mobile device receiver of the mobile device 2, the mobile device processing means of the mobile device 2 update corresponding element of the mobile device seller database, the element comprising initial unique data to be updated. Moreover, the updated unique data may further comprise advertisement data and data on reward products and/or services of a certain registered seller.

According to another embodiment of the present invention, the initial and/or updated unique data transmitted by the processing center 1 to the mobile device 2 may comprise graphic data and/or numeric data, and/or letter identifying a certain registered seller, wherein some of said transmitted data form an unique logotype of the certain registered seller.

According to present invention, the mobile device 2 is implemented as form a mobile phone. According to another embodiment of the present invention, the mobile device 2 may be in the form of a smartphone, tablet PC, laptop, pocket PC, communicator or any other commercially available mobile device.

According to still another embodiment of the present invention, the mobile device 2 may comprise a mobile device display integrated into the mobile device 2 for displaying received initial unique data or updated unique data recorded in an element of the mobile device seller database stored in the mobile device data storage 5, wherein the mobile device data storage 5 is connected with the mobile device display. Thus, when displayed unique data comprise news data and/or advertisement data, data on seller special products/services, data on events organized by the seller and/or etc, the user of the certain mobile device 2 comprising a mobile device display may read the news and/or look through the advertisement data, and/or learn about special products/services, and/or to learn about the events organized by the certain seller, respectively. In addition, the mobile device 2 may further comprise mobile device input means connected with the mobile device display for controlling operations relating to data displayed by the mobile device display. For example, by using the mobile device input means the user of the mobile device 2 may select special products/services displayed on the mobile device display to further buy them for reward points initially credited to the registered customer or credited upon buying products and/or services for cash. Furthermore, the mobile device display of the mobile device 2 may display desired data automatically and/or in a response to operations performed by the user with the help of the mobile device input means. In yet another embodiment of the present invention, the mobile device 2 may comprise at least two mobile device displays for displaying desired data and/or may output some data requested by the user with the help of the mobile device input means to an external display.

The mobile device input means may be implemented as a mobile device keyboard and/or at least one button. The mobile device display may be in the form of LED, ELD, Electronic paper E Ink, PDP, LCD, HPA, TFT, OLED, SED, IMOD, laser display and other underlying and three dimensional display technologies. In particular, the mobile device display and mobile device input means may be implemented as a touch screen display or a touch screen display and at least one button.

The mobile device also comprises a mobile device generator for generating mobile device data corresponding to certain unique data recorded in an element of the mobile device seller database stored in the mobile device data storage 5. Therefore, the generated mobile device data also correspond to a certain seller ID and mobile device ID. The generated mobile device data represent, in particular, selected products/services which a user of the mobile device 2 wants to buy for reward points. Furthermore, the mobile device seller database stored in the mobile device data storage 5 is controlled by the mobile device processing means of the mobile device 2.

In particular, in the above described case when the first initial unique data are communicated to the mobile device 2, first mobile device data are generated by a mobile device generator on the basis of the received first initial unique data.

In another embodiment of the present invention, the mobile device generator of the mobile device 2 may be connected with a mobile device display such that to display the generated mobile device data.

In still another embodiment of the present invention, the mobile device generator of the mobile device 2 may generate mobile device data automatically or in response to an operation carried out by the user of the mobile device 2 with the help of the mobile device input means.

In yet another embodiment of the present invention, the mobile device input means are used for entering data such as a sum of money paid by cash for any products/services offered by a certain seller in the seller's sales outlet, wherein the entered data are stored in the mobile device data storage 5, and the mobile device 2 is capable to communicate the entered data to the at least one processing center 1 to update corresponding data on the basis of the communicated data.

In still yet another embodiment of the present invention, the generated mobile device data are a code, the code comprising graphic data and/or numeric data and/or letter data for representing a certain seller and mobile device IDs and selected seller's products/services, events, news, special offers, advertisement or etc available, if any, when unique data are received. In one embodiment of the present invention, the code generated by the mobile device generator of the mobile device 2 may be in the form of QR code or NFC code or any other two-dimensional bar code.

According to the present invention, the mobile device transmitter of the mobile device 2 is further connected with the mobile device generator such that to communicate the mobile device data generated by the mobile device generator of the mobile device 2 to the validator 3 of the system 0.

According to one embodiment of the present invention, the mobile device generator of the mobile device 2 generates mobile device data in the form of sound signal, and the mobile device transmitter is capable to transmit the generated sound signal to the validator 3.

The validator 3 of the system 0 comprises a validator receiver connected with the mobile device transmitter of the mobile device 2 in a wire and/or wireless manner for receiving the mobile device data transmitted by the mobile device 2. The validator 3 also comprises a validator reader connected with the validator receiver for reading the received mobile device data such that to identify products/services which a user of the mobile device 2 wants to buy for available reward points credited for buying in cash.

The validator 3 further comprises validator input means for entering data, such as a sum of money paid by cash for any products/services offered by a certain seller in the seller's sales outlet.

In the validator 3 of the system 0 the read mobile device data and entered data are stored into the validator data storage 6 of the validator 3, wherein the validator data storage 6 is controlled by the validator processing means of the validator 3.

According to the present inventions, the validator 3 further comprises a validator generator, the validator generator being connected with the validator data storage 6, for generating validator data corresponding to the read mobile device data and/or entered data stored in the validator data storage 6 of the validator 3. Therefore, the generated validator data correspond to a certain seller ID and mobile device ID. Moreover, the generated validator data represent, in particular, selected products/services to be provided to a user of the mobile device 2 for reward points and/or data corresponding to products/services bought by the user by cash in the seller's sales outlet. The generated validator data are stored into the validator data storage 6.

Furthermore, according to the present invention the validator 3 further comprises a validator transmitter integrated into the validator 3 for communicating the validator data to the processing center 1 of the system 0 within a validator data flow when a connection between the validator 3 and processing center 1 is established, wherein the validator transmitter is connected with the validator data storage 6 such that to receive the generated validator data.

In particular, in the above described case when the mobile device data are generated by a mobile device generator, the validator 3 reads the generated first mobile device data and further generates first validator data corresponding to the read mobile device data, and communicates the generated first validator data to the processing center.

In one embodiment of the present invention, each of the read mobile device data, entered data and generated validator data stored in the validator data storage 6 are stored in a special validator data storage element of the validator data storage 6. In another one embodiment of the present invention, the validator 3 may comprise at least two data storages 6 for storing the read mobile device data, entered data and generated validator data.

In another one embodiment of the present invention, the validator 3 of the system 0 further comprises a validator display for displaying the entered data, read mobile device data and/or generated validator data stored in the validator data storage 6. The validator display may be in the form of any commercial available display, such as LED, ELD, Electronic paper E Ink, PDP, LCD, HPA, TFT, OLED, SED, IMOD, laser display or any other display based on underlying and three dimensional display technologies.

In another one embodiment of the present invention, the validator display and validator input means of the validator 3 may be in the form of a touch screen display, the touch screen display being used for entering data, displaying the entered data, read mobile device data and any other data stored in the validator data storage 6 of the validator 3, and controlling operations corresponding to the data displayed by the validator display. According to still another embodiment of the present invention, the validator input means of the validator 3 may be in the form of a keyboard, at least one button, display and/or touch screen display.

According to one embodiment of the present invention the validator 3 may have a unique validator identifier (validator ID) initially assigned to each validator of the system, when initial connection between a certain validator 3 and processing center 1 is established. Therefore, in this embodiment of the present invention, the generated validator data correspond to a certain seller ID, mobile device ID and validator ID.

In yet another embodiment of the present invention, the validator 3 may collect the read mobile device data and/or entered data stored in validator data storage 6 when a connection between the validator 3 and processing center is not established. In this case the validator processing means have special instructions such that to periodically request a connection with the processing center 1 by means of the validator transmitter of the validator 3 in order to communicate the collected data within a communicated data flow to the processing center 1 of the system 0 when the connection is established.

According to other embodiments of the present invention, the validator 3 of the system 0 may further comprise a validator recognizer for recognizing the mobile device data read by the validator reader (not shown). In particular, in an embodiment of the present invention when the mobile device data generated by the mobile device generator are code, such as QR code, comprising coded data on products/services bought by a user of the mobile device 2 for reward points, coded seller and mobile device IDs, the validator recognizer is used to recognize the code such that to decode data on products/services bought by a user of the mobile device 2 for reward points, coded seller and mobile device IDs from the generated code. In the embodiment of the present invention when the validator 3 has a unique validator ID, the generated code further comprises the coded validator ID, and the validator recognizer may further recognize the coded validator ID such that to identify the validator used. In one embodiment of the present invention, a validator display of the validator 3 may display mobile device data recognized by the validator recognizer.

According to still another embodiment of the present invention, the validator 3 of the system 0 may be in the form of a validator camera for capturing the generated mobile device data displayed by the mobile device display of the mobile device 2. According to one embodiment of the invention, the validator 3 may be implemented as a mobile phone, communicator, tablet PC or any other mobile device. In still another embodiment of the present invention, the validator recognizer of the validator 3 may recognize the mobile device data captured by the validator camera. In yet another embodiment of the present invention, the validator display of the validator 3 may further display the mobile device data captured by the validator camera and recognized by the validator recognizer.

Furthermore, in one embodiment of the present invention, the validator 3 of the system 0 may be in the form of any commercially available validator scanner capable of scanning the generated mobile device data, the mobile device data being displayed by the mobile device display of the mobile device 2. According to another embodiment of the present invention, the validator recognizer of the validator 3 may recognize the mobile device data scanned by the validator scanner. In still another embodiment of the present invention, the validator display of the validator 3 may display the mobile device data scanned by the validator scanner and recognized by the validator recognizer.

In the present invention, the processing center receiver of the processing center 1 of the system 0 further receives the validator data flow communicated by the validator transmitter of the validator 3, wherein the validator data flow comprises at least the validator data generated by the validator generator of the validator 3.

In one embodiment of the present invention, the validator data generated by the validator generator of the validator 3 may correspond to the read mobile device data and/or entered data collected in the validator data storage 6 of the validator 3 when a connection between the validator 3 and processing center 1 is not established. Thus, the validator data flow communicated to the processing center 1 may correspond to at least one seller ID and/or at least one mobile device ID. According to another embodiment of the present invention, the communicated validator data flow, if required, may further correspond to at least one validator ID.

The received validator data flow is processed by the processing center processing means of the processing center 1 such that to identify seller ID and mobile device ID and determine data on selected products/services to be provided to a user of the mobile device 2 for reward points and/or data on products/services bought by the user by cash in a sales outlet of a seller, all of said data corresponding to the identified seller ID of the seller and identified mobile device ID of the mobile device 2 of the user. Then the processed validator data are recorded into a certain element of the processing center seller database stored in the processing center data storage 4 in accordance with the identified seller ID to which the certain processing center seller database element also corresponds, wherein the processed validator data update corresponding element of the processing center seller database by re-recording the validator data previously recorded thereinto, if required, and/or filling corresponding element of the processing center seller database with the processed validator data. Each seller ID and at least one mobile device ID corresponding to a certain seller ID are stored in a certain element of the processing center seller database stored in the processing center data storage 4 as user data. Therefore, when new mobile device are registered in the processing center 1 of the system 0 under a new mobile device ID for a registered seller having an assigned seller ID, the processing center processing means update the user data corresponding to the assigned seller ID by adding a new mobile device ID. According to another embodiment of the present invention, the user data further comprise a validator ID corresponding to the seller ID. Thus, in the present invention, the processing center processing means of the processing center 1 may update corresponding user data on the basis of the processed validator data.

Upon receiving the communicated validator data flow, the processing center processing means of the processing center 1 update certain unique data communicated to a certain mobile device 2 within the corresponding processing center data flow on the basis of the validator data of the received validator data flow. The updated processing center data flow is communicated from the processing center 1 by the processing center transmitter to the mobile device 2. Then, the mobile device processing means of the mobile device 2 update the previously recorded unique data in a certain element of the mobile device seller database stored in the mobile device data storage 5 on the basis of the updated unique data received by the mobile device 2 with the transmitted processing center data flow using the mobile device receiver of the mobile device 2.

In particular, in the above described case when the first validator data are communicated to the processing center 1, the processing cener 1 stores the received first validator data corresponding to the mobile device ID of the mobile device with the first program application installed therein and further corresponding to the first registered seller in the first element of the processing cener data storage 4 and further updates the first unique data initially communicated to corresponding mobile device on the basis of the received first validator data.

For example, when a user of the mobile device 2 buys some products/services by cash, a user of the validator 3 used in the sales outlet enters the paid sum of cash money by means of the validator input means such that to further communicate these entered data to the processing center 1 of the system 0 as a part of the generated validator data within the validator data flow in order to credit additional reward points to the user of the mobile device 2 by means of the processing center processing means using corresponding recalculation coefficient for recalculating the paid sum of cash money to the reward points. Then, the processing center 1 communicates data on these new credited reward points to the same mobile device 2 as a part of unique data communicated within the processing center data flow such that to update reward points available to the user of the mobile device 2, specifically to add the newly credited reward points to the previously credited reward points already available in the mobile device. Moreover, when a user selects in the mobile device 2 of the user some available products/services such that to buy them for reward points available to the user, the mobile device 2 communicates data on the selected products/services to be provided for the reward points to the validator 3 as a part of the mobile device data generated by the mobile device generator. Then, the validator reader of the validator 3 reads the transmitted mobile device data to identify the products/services which the user of the mobile device 2 wants to buy for reward points, and the validator 3 communicates these read mobile device data to the processing center 1 of the system 0 as a part of the generated validator data within the validator data flow. The read mobile device data are further processed by the processing center processing means in order to update the data on previously credited reward points in corresponding element of the processing center seller database stored in the processing center data storage 4, and then the processing center 1 communicates the data on updated reward points to the same mobile device 2 as a part of unique data communicated within the processing center data flow such that to update reward points available to the user of the mobile device 2, specifically to reduce previously credited and currently available reward points in the mobile device 2 by the reward points paid for the products/services.

In one embodiment of the present invention, the processing means of the processing center 1 may generate at least one report corresponding to the user data, specifically to the seller ID and mobile device ID and being based on the validator data stored in a certain element of the processing center seller database stored in the processing center data storage 4.

According to further embodiment of the present invention, the validator processing means of the validator 3 send a request to the processing center 1 of the system 0 to confirm, for example, whether the mobile device is registered for the certain seller and/or the user of the mobile device has required amount of reward points to buy desired products/services. The processing center processing means of the processing center 1 process the received request such that to compare the read mobile device data corresponding to certain seller ID and mobile device ID with both the user data and unique data stored in a certain element of the processing center seller database stored in the processing center data storage 4. The processing center processing means of the processing center 1 further send a response back to the validator 3, the response corresponding to the sent request and comprising the required confirmation data.

The processing center transmitter used in the processing center 1 of the system 0 may be implemented as additional hardware such as LAN transmitter, Bluetooth transmitter, Wi-Fi transmitter, IR-transmitter, WiMAX transmitter, 3G or 4G transmitter, or at least one other commercially available transmitter each using at least one other technology that may be known or developed in the prior art, or any combination thereof. Meanwhile, the processing center transmitter of the processing center 1, mobile device transmitter of the mobile device 2 and/or validator transmitter of the validator 3 may be implemented identically or differently from each other as defined above for the processing center transmitter of the processing center 1. Furthermore, the mobile device receiver of the mobile device 2, the validator receiver of the validator 3 and the processing center receiver of the processing center 1 are implemented so that to receive desired data flow from the processing center transmitter, mobile device transmitter and validator transmitter, respectively. In particular, receivers integrated into corresponding components of the system 0 may be implemented identically to corresponding transmitters which communicate desired data to those receivers.

The processing center processing means of the processing center 1, mobile device processing means of the mobile device 2 and/or validator processing means of the validator 3 may be implemented identically or differently from each other as described here for the processing center processing means. The processing center data storage 4 of the processing center 1, mobile device data storage 5 of the mobile device 2 and/or validator data storage 6 of the validator 3 may be implemented identically or differently from each other as described here for the processing center data storage 4.

Furthermore, the mobile device input means and display of the mobile device and/or validator input means and display of the validator may be implemented identically or differently from each other as described here for the mobile device input means and display of the mobile device, respectively.

In the present invention, in order to enhance consumer loyalty with a mobile device, a method is used, the method including the steps generating at least first data and second data by at least one processing center, the first data corresponding to a first seller registered in the at least one processing center and second data corresponding to a second seller registered in the at least one processing center, and further storing the generated first data and second data in a data storage of the corresponding processing center; receiving at least one of the generated first data and second data by the at least one mobile device registered in the at least one processing center, the received data being communicated from the at least one processing center; generating mobile device data by at least one registered mobile device, the generated mobile device data corresponding to at least one of the received data; reading the generated mobile device data by at least one validator; generating validator data by the at least one validator, the validator data corresponding to the read mobile data and communicating the generated validator data to the at least one processing center; receiving the communicated validator data by at least one processing center and storing the received validator data in the data storage of the corresponding processing center; updating at least one of the first data and second data stored in the corresponding data storage of the at least one processing center on the basis of the received validator data.

A number of exemplary embodiments have been described above. Nevertheless, it will be understood that various modifications may be made. For example, suitable results may be achieved if the described components in a described system and method are combined in a different manner and/or replaced or supplemented by other components or their equivalents. Accordingly, other implementations are within the scope of the following claims.

1. A system for enhancing consumer loyalty with a mobile device, the system comprising:
at least one processing center comprising a processing means for generating at least first data and second data, the first data corresponding to a first seller registered in the at least one processing center and second data corresponding to a second seller registered in the at least one processing center, wherein the at least one processing center is capable to communicate the generated first data and second data and capable to receive and update data, and further comprises a data storage for storing at least the generated first data and second data;
at least one mobile device registered in the at least one processing center, wherein each mobile device of the at least one mobile device receives at least one of the communicated first data and second data and further generates mobile device data corresponding to at least one of the received data, the system further comprising
at least one validator registered in the at least one processing center and comprising a validator reader for reading the generated mobile device data from the at least one mobile device, wherein each validator of the at least one validator generates validator data corresponding to the read mobile device data and communicates the generated validator data to the at least one processing center;
wherein each processing center of the at least one processing center receives the communicated validator data to store in the corresponding data storage and further updates at least one of the first data and second data on the basis of the validator data.

2. The system according to claim 1, wherein the at least one mobile device is a mobile phone.

3. The system according to claim 1, wherein the at least one validator is a mobile phone, communicator or tablet PC.

4. The system according to claim 1, wherein the at least one validator further comprises input means for entering data, and the generated validator data correspond to the read mobile device data and/or the entered data.

5. The system according to claim 4, wherein the input means of the at least one validator are a keyboard and/or at least one button.

6. The system according to claim 1, wherein the at least one mobile device further comprises input means for entering data and capable to communicate the entered data to the at least one processing center to update at least one of the first data and second data on the basis of the communicated data.

7. The system according to claim 6, wherein the input means of the at least one mobile device are a keyboard and/or at least one button.

8. The system according to claim 1, wherein each validator of the at least one validator further comprises a validator display for displaying the mobile device data read by corresponding validator reader.

9. The system according to claim 8, wherein the validator display is a touch screen display or a touch screen display and at least one button.

10. The system according to claim 1, wherein each mobile device of the at least one mobile device further comprises a mobile device display for displaying the generated mobile device data.

11. The system according to claim 10, wherein the mobile device display is a touch screen display or a touch screen display and at least one button.

12. The system according claim 10, wherein the validator reader of each validator of the at least one validator is a camera for capturing the mobile device data displayed by the mobile device display.

13. The system according claim 12, wherein each validator of the at least one validator further comprises a recognizer for recognizing the mobile device data captured by the camera.

14. The system according to claim 10, wherein the validator reader of each validator of the at least one validator is a scanner for scanning the mobile device data displayed by the mobile device display.

15. The system according to claim 10, wherein the generated mobile device data are a code, the code being displayed by the corresponding mobile device display.

16. The system according to claim 15, wherein the code is a QR code or NFC code.

17. The system according to claim 10, wherein the generated mobile device data are a QR code or NFC code.

18. The system according to claim 1, wherein each validator of the at least one validator collects the read mobile device data when said each validator is not connected with the at least one processing center.

19. The system according to claim 1, wherein each validator of the at least one validator sends a request to the at least one processing center for comparing certain read mobile device data with at least one of the first data and second data stored in the corresponding data storage and receiving a center response from the corresponding processing center, the response corresponding to the sent request.

20. The system according to claim 1, wherein each processing center of the at least one processing center is a server, website or satellite.

21. A method for enhancing consumer loyalty with a mobile device, the method including:
generating at least first data and second data by at least one processing center, the first data corresponding to a first seller registered in the at least one processing center and second data corresponding to a second seller registered in the at least one processing center, and further storing the generated first data and second data in a data storage of the corresponding processing center;
receiving at least one of the generated first data and second data by the at least one mobile device registered in the at least one processing center, the received data being communicated from the at least one processing center;
generating mobile device data by at least one registered mobile device, the generated mobile device data corresponding to at least one of the received data;
reading the generated mobile device data by at least one validator;
generating validator data by the at least one validator, the validator data corresponding to the read mobile data and communicating the generated validator data to the at least one processing center;
receiving the communicated validator data by at least one processing center and storing the received validator data in the data storage of the corresponding processing center;
updating at least one of the first data and second data stored in the corresponding data storage of the at least one processing center on the basis of the received validator data.

22. The method according to claim 21, further including
sending a request by the at least one validator to the at least one processing center for comparing read mobile device data with at least one of the first data and second data stored in the corresponding data storage of the at least one processing center; and
receiving a response by the at least one validator from the corresponding processing center of the at least one processing center, the response corresponding to the sent request.
